(19) United States
(12) Patent Application Publication
(10) Pub. No.: US 2024/0199988 A1
(43) Pub. Date: Jun. 20, 2024

(54) POWDERED DETERGENT COMPOSITION

(71) Applicant: Henkel AG & Co. KGaA, Düsseldorf (DE)

(72) Inventors: Emmanuel DIMOTAKIS, Oradell, NJ (US); Andrew Neal BERNARD, East Lyme, CT (US); Casey Elphege CAMIRE, Wallingford, CT (US); Mariusz HILDEBRANSKI, Shelton, CT (US)

(73) Assignee: Henkel AG & Co. KGaA, Düsseldorf (DE)

(21) Appl. No.: 18/508,550

(22) Filed: Nov. 14, 2023

Related U.S. Application Data
(60) Provisional application No. 63/429,448, filed on Dec. 1, 2022.

(51) Int. Cl. C11D 3/10; C11D 1/12; C11D 3/20; C11D 3/22; C11D 3/32; C11D 3/37; C11D 3/386; C11D 3/395; C11D 17/00

(52) U.S. Cl. CPC C11D 3/10; C11D 1/123; C11D 3/2068; C11D 3/2082; C11D 3/221; C11D 3/222; C11D 3/32; C11D 3/3761; C11D 3/38609; C11D 3/3951; C11D 3/3953; C11D 17/0047

(57) ABSTRACT

The present disclosure provides a detergent composition comprising soda ash, an acid, a fatty alcohol ethoxylate, an anionic surfactant, a detergent polymer, and a binder selected from a sugar, a starch, a polyol, and any combination thereof, wherein the composition is in the form of a powder. The composition can further comprise additional components, such as a bleaching agent, a bleach activator, and at least one enzyme. The detergent composition can be provided in the form of a compressed shape, such as a tablet.

### BACKGROUND

Powdered laundry detergent typically is used for heavy duty loads like sheets and towels or heavily stained loads. Powdered detergent offers a quick, easy laundry process, often with better efficacy and value compared to liquid and pod-type detergents. However, powdered detergents can suffer from dissolvability issues, especially in cold water, and messiness while measuring.

Other solid detergent forms using pre-measured dosing, such as tablets and sheets, have been developed but performance is still limited. Issues, including aesthetics, strength, and performance, associated with these solid forms correlate to several factors, often the detergent composition, surfactant loading, and stability.

In addition, there is a push for improving detergent sustainability and to reduce issues associated with drainage systems and water treatment plants. For example, phosphates are a common additive in detergents but pose potential health problems and environmental hazards. Undissolved materials from powdered detergents can clog pipes and drains.

Thus, there is a need for a powdered detergent with combined improved properties, such as stability, aesthetics, performance attributes, and sustainability.

### BRIEF SUMMARY

The present disclosure relates to a detergent composition comprising soda ash, an acid, a fatty alcohol ethoxylate, an anionic surfactant, a detergent polymer, and a binder selected from a sugar, a starch, a polyol, and any combination thereof, wherein the composition is in the form of a powder.

In some aspects, the soda ash comprises light soda ash, medium dense soda ash, dense soda ash, sodium bicarbonate, or a combination thereof. In other aspects, the soda ash comprises a mixture of light soda ash and dense soda ash. In some aspects, the soda ash comprises light soda ash and dense soda ash in a weight ratio of about 1:1.

In some aspects, the acid is an organic acid. In some aspects, the organic acid comprises citric acid.

In some aspects, the fatty alcohol ethoxylate is a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate.

In some aspects, the anionic surfactant comprises linear alkylbenzene sulfonate, a methyl ester sulfonate, or a combination thereof. In some aspects, the anionic surfactant comprises a methyl ester sulfonate.

In some aspects, the detergent polymer comprises a homopolymer of acrylic acid.

In some aspects, the composition further comprises a bleaching agent and optionally a bleach activator.

In some aspects, the bleaching agent comprises a hydrogen peroxide source. In some aspects, the hydrogen peroxide source comprises at least one inorganic perhydrate salt comprising a perborate salt, a percarbonate salt, a perphosphate salt, a persulfate salt, a persilicate salt, or a combination thereof. In some aspects, the at least one inorganic perhydrate salt comprises sodium percarbonate. In some aspects, the composition further comprises tetraacetylethylenediamine (TAED) as a bleach activator.

In some aspects, the composition further comprises at least one enzyme. In some aspects, the at least one enzyme comprises a protease, an amylase, a mannanase, a lactase, a lipase, a perhydrolase, an oxidoreductase, an endocellulase, an exocellulase, or a combination thereof.

In some aspects, the composition comprises light soda ash, dense soda ash, citric acid, a C₁₂-C₁₅ fatty alcohol ethoxylate with 7 moles of ethoxylate, a methyl ester sulfonate, a homopolymer of acrylic acid, sodium percarbonate, tetraacetylethylenediamine (TAED), a protease, an amylase, and either sorbitol or dextrose.

In some aspects, the composition is in the form of a compressed shape (e.g., tablet). In some aspects, the compressed shape (e.g., tablet) dissolves within about 4 to about 15 minutes when the compressed shape (e.g., tablet) is added to 1 L water at about 21° C. (about 70° F.) with stirring using a tergotometer.

### DETAILED DESCRIPTION

Provided herein is a detergent composition comprising soda ash, an acid, a fatty alcohol ethoxylate, an anionic surfactant, a detergent polymer, and a binder selected from a sugar, a starch, a polyol, and any combination thereof, wherein the composition is in the form of a powder.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little no specified ingredient/component, such as less than about 5 wt %, less than about 4 wt %, less than about 3 wt %, less than about 2 wt %, less than about 1 wt %, less than about 0.5 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “process” and “method” can be used interchangeably.

“Amylases” as used in the present application means: class of enzymes that catalyze the hydrolysis of starch into sugars such as glucose and maltose.

“Mannanases” as used in the present application means: class of enzymes that catalyze the hydrolysis of mannose derivatives.

“Mannose” as used in the present application means: sugar monomer of the aldohexose series of carbohydrates.

“Lipases” as used in the present application means: class of enzymes that catalyze the hydrolysis of fats or lipids.

“Proteases” as used in the present application means: class of enzymes that catalyze the hydrolysis of proteins.

“Cellulase” as used in the present application means: class of enzymes that catalyze the cellulolysis or hydrolysis of cellulose.

“Endocellulases” as used in the present application means: class of cellulases that hydrolyze glycoside links within cellulose chains.

“Exocellulases” as used in the present application means: class of cellulases that hydrolyze glycoside links at the ends of cellulose chains.

### Powdered Detergent Composition

In some aspects, the present disclosure is directed to a detergent composition comprising soda ash, an acid, a fatty alcohol ethoxylate, an anionic surfactant, a detergent polymer, and a binder selected from a sugar, a starch, a polyol, and any combination thereof, wherein the composition is in the form of a powder.

The present disclosure is predicated on the discovery that traditional fillers are not necessary to provide a powdered detergent composition that forms a fully clear or semi-translucent detergent solution combined with improved aesthetics, strength, dissolution profile, and performance properties. Accordingly, in the absence of conventional fillers, the detergent composition comprises a binder that can be directly compressible and/or is granular. In some aspects, the binder is a sugar, a starch, a polyol, or any combination thereof. In some aspects, the binder consists of a sugar a starch, a polyol, or any combination thereof. The sugar can be any suitable sugar, but typically is a monosaccharide or disaccharide. Examples of monosaccharides include dextrose, glucose, fructose, galactose, xylose, and ribose. Examples of disaccharides include lactose, sucrose, and maltose. The starch can be, for example, any suitable plant-based starch, such as starch from corn, maize, tapioca, potatoes, rice, cassava, wheat, arrowroot, etc. The polyol typically is a sugar alcohol, such as ethylene glycol, glycerol, sorbitol, erythritol, threitol, arabitol, ribitol, galactitol, fucitol, iditol, inositol, volemitol, isomalt, mannitol, maltotriitol, maltotetratol, xylitol, or polyglycitol. In some aspects, the binder is dextrose. In other aspects, the binder is sorbitol.

In some aspects, the detergent composition comprises from about 10 percent by weight (wt %) to about 75 wt % of a binder (e.g., a sugar, a starch, a polyol, or any combination thereof) relative to the total weight of the composition. For example, the binder can be present in an amount from about 10 wt % to about 70 wt %, about 10 wt % to about 65 wt %, about 10 wt % to about 60 wt %, about 10 wt % to about 55 wt %, about 10 wt % to about 50 wt %, about 10 wt % to about 45 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 19 wt %, about 10 wt % to about 18 wt %, about 11 wt % to about 20 wt %, about 11 wt % to about 19 wt %, about 12 wt % to about 20 wt %, about 12 wt % to about 19 wt %, about 12 wt % to about 18 wt %, about 13 wt % to about 20 wt %, about 13 wt % to about 19 wt %, about 13 wt % to about 18 wt %, about 14 wt % to about 20 wt %, about 14 wt % to about 19 wt %, about 14 wt % to about 18 wt %, about 15 wt % to about 75 wt %, about 15 wt % to about 70 wt %, about 15 wt % to about 65 wt %, about 15 wt % to about 60 wt %, about 15 wt % to about 55 wt %, about 15 wt % to about 50 wt %, about 15 wt % to about 45 wt %, about 15 wt % to about 40 wt %, about 15 wt % to about 35 wt %, about 15 wt % to about 30 wt %, about 15 wt % to about 25 wt %, about 15 wt % to about 20 wt %, about 15 wt % to about 20 wt %, about 15 wt % to about 19 wt %, about 15 wt % to about 18 wt %, about 20 wt % to about 75 wt %, about 20 wt % to about 70 wt %, about 20 wt % to about 65 wt %, about 20 wt % to about 60 wt %, about 20 wt % to about 55 wt %, about 20 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 30 wt % to about 75 wt %, about 30 wt % to about 70 wt %, about 30 wt % to about 65 wt %, about 30 wt % to about 60 wt %, about 30 wt % to about 55 wt %, about 30 wt % to about 50 wt %, about 30 wt % to about 45 wt %, about 30 wt % to about 40 wt %, about 30 wt % to about 35 wt %, about 40 wt % to about 75 wt %, about 40 wt % to about 70 wt %, about 40 wt % to about 65 wt %, about 40 wt % to about 60 wt %, about 40 wt % to about 55 wt %, about 40 wt % to about 50 wt %, about 40 wt % to about 45 wt %, about 50 wt % to about 75 wt %, about 50 wt % to about 70 wt %, about 50 wt % to about 65 wt %, about 50 wt % to about 60 wt %, about 50 wt % to about 55 wt %, about 60 wt % to about 75 wt %, about 60 wt % to about 70 wt %, about 60 wt % to about 65 wt %, about 70 wt % to about 75 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 25 wt %, about 30 wt %, about 35 wt %, about 40 wt %, about 45 wt %, about 50 wt %. about 55 wt %, about 60 wt %, about 65 wt %, about 70 wt %, or about 75 wt % of the total weight of the composition.

In some aspects, the detergent composition is substantially free of a conventional filler, such as sodium sulfate, sodium chloride, a zeolite, or a cellulose (e.g., cellulose, carboxymethyl cellulose, etc.).

Soda ash is sodium carbonate and can be in the form of light soda ash and dense

soda ash. Light soda ash has a bulk density of about 0.5-0.78 g/ml, and typically an average particle size of about 100-115 μm. Dense soda ash has a bulk density of about >0.9 g/ml (e.g., 0.95-1.15 g/ml), and typically an average particle size of about 300-500 μm.

In some aspects, the soda ash comprises light soda ash, medium dense soda ash, dense soda ash, sodium bicarbonate, or a combination thereof. In some aspects, the detergent composition will comprise a mixture of light soda ash and dense soda ash. It was discovered that in some aspects, light soda ash can absorb one or more liquid components of the detergent composition to provide a powdered detergent that can be compressed. When both light soda ash and dense soda ash are used, the light soda ash and dense soda ash can have any suitable weight ratio. For example, the light soda ash and dense soda ash can have a weight ratio that is within a range of about 1:10 to about 10:1 (e.g., about 1:10, about 1:9, about 1:8, about 1:7, about 1:6, about 1:5, about 1:4, about 1:3, about 1:2, about 1:1, about 10:1, about 9:1, about 8:1, about 7:1, about 6:1, about 5:1, about 4:1, about 3:1, about 2:1, about 1.8:1, about 1.5:1, about 1.3:1, about 1.2:1, about 1.1:1, about 1.08:1, or about 1.05:1). In some aspects, the light soda ash and dense soda ash have a weight ratio of about 1:1 (e.g., about 1.1:1, about 1.08:1, about 1.05:1, about 1:1, about 1:1.05, about 1:1.08, or about 1:1.1).

In some aspects, the detergent composition comprises from about 10 wt % to about 40 wt % of soda ash (e.g., light soda ash, dense soda ash, or a combination of both) relative to the total weight of the composition. For example, the soda ash can be present in an amount from about 10 wt % to about 38 wt %, about 10 wt % to about 35 wt %, about 10 wt % to about 32 wt %, about 12 wt % to about 40 wt %, about 12 wt % to about 38 wt %, about 12 wt % to about 35 wt %, about 12 wt % to about 32 wt %, about 15 wt % to about 40 wt %, about 15 wt % to about 38 wt %, about 15 wt % to about 35 wt %, about 15 wt % to about 32 wt %, about 18 wt % to about 40 wt %, about 18 wt % to about 38 wt %, about 18 wt % to about 35 wt %, about 18 wt % to about 32 wt %, about 20 wt % to about 40 wt %, about 20 wt % to about 38 wt %, about 20 wt % to about 35 wt %, about 20 wt %, about 32 wt %, about 22 wt % to about 40 wt %, about 22 wt % to about 38 wt %, about 22 wt % to about 35 wt %, about 22 wt % to about 32 wt %, about 24 wt % to about 40 wt %, about 24 wt % to about 38 wt %, about 24 wt % to about 35 wt %, about 24 wt % to about 32 wt %, about 26 wt % to about 40 wt %, about 26 wt % to about 38 wt %, about 26 wt % to about 35 wt %, about 26 wt % to about 32 wt %, about 28 wt % to about 40 wt %, about 28 wt % to about 38 wt %, about 28 wt % to about 35 wt %, about 28 wt % to about 32 wt %, about 30 wt % to about 40 wt %, about 30 wt % to about 38 wt %, about 30 wt % to about 35 wt %, about 30 wt % to about 32 wt %, about 31 wt % to about 40 wt %, about 31 wt % to about 38 wt %, about 31 wt % to about 35 wt %, about 31 wt % to about 33 wt %, about 15 wt %, about 18 wt %, about 20 wt %, about 22 wt %, about 24 wt %, about 26 wt %, about 28 wt %, about 30 wt %, about 31 wt %, about 32 wt %, about 33 wt %, about 34 wt %, about 35 wt %, about 36 wt %, about 37 wt %, about 38 wt %, about 39 wt %, or about 40 wt % of the total weight of the composition.

The detergent composition comprises an acid, which is any suitable moiety with a pH<7. In general, the acid will react with the basic soda ash to provide an active detergent. In some aspects, the acid is an inorganic acid or an organic acid. Examples of an inorganic acid include hydrochloric acid, nitric acid, nitrous acid, sulfuric acid, sulfurous acid, phosphoric acid, boric acid, hydrobromic acid, hydroiodic acid, perchloric acid, and combinations thereof. In some aspects, the acid is a weak acid such that the acid has a pKa of 2 or greater (e.g., pKa is 2 to 50). Examples of a weak acid include, e.g., an organic acid or carbonic acid, hydrocyanic acid, phosphoric acid, sulfurous acid, nitrous acid, or a combination thereof.

In some aspects, the acid in the detergent composition is an organic acid, which in some instances can additionally act as a chelating agent. The organic acid can contain one or more (e.g., 1, 2, or 3) carboxylic acid groups, which can be used singly or in combination. For example, monocarboxylic acids include formic acid, acetic acid, propionic acid, butanoic acid, quinic acid, shikimic acid, lactic acid, sorbic acid, caproic acid, capyrylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid. In some aspects, the detergent composition comprises citric acid.

In some aspects, the detergent composition comprises from about 10 wt % to about 30 wt % of acid (e.g., an organic acid, such as citric acid) relative to the total weight of the composition. For example, the acid can be present in an amount from about 10 wt % to about 28 wt %, about 10 wt % to about 25 wt %, about 10 wt % to about 20 wt %, about 12 wt % to about 30 wt %, about 12 wt % to about 28 wt %, about 12 wt % to about 25 wt %, about 12 wt % to about 20 wt %, about 15 wt % to about 30 wt %, about 15 wt % to about 28 wt %, about 15 wt % to about 25 wt %, about 15 wt % to about 20 wt %, about 18 wt % to about 30 wt %, about 18 wt % to about 28 wt %, about 18 wt % to about 25 wt %, about 18 wt % to about 22 wt %, about 20 wt % to about 30 wt %, about 20 wt % to about 28 wt %, about 20 wt % to about 25 wt %, about 20 wt % to about 22 wt %, about 22 wt % to about 30 wt %, about 22 wt % to about 28 wt %, about 22 wt % to about 25 wt %, about 24 wt % to about 30 wt %, about 24 wt % to about 28 wt %, about 24 wt % to about 26 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt % of the total weight of the composition.

The detergent composition comprises a fatty alcohol ethoxylate as a nonionic surfactant. In general, the fatty alcohol ethoxylate will have a chemical structure of formula (I):

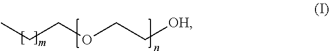

in which m is 10 to 16 (e.g., 10, 11, 12, 13, 14, 15, or 16) to form a C₁₂-C₁₈ alkyl (e.g., C₁₂, C₁₃, C₁₄, C₁₅, C₁₆, C₁₇, and C₁₈), and n is 1 to 15 (e.g., 1, 2, 3, 4, 5, 6, 7, 8, 9, 10, 11, 12, 13, 14, or 15). The fatty alcohol ethoxylate typically will contain a range of alkyl groups, such as C₁₂-C₁₅ or C₁₂-C₁₄ and can contain branches. In some aspects, the fatty alcohol ethoxylate contains 1 to 9 moles (e.g., 1 to 7 moles or about 7 moles) of ethoxylate per mole of alcohol. In some aspects, the fatty alcohol ethoxylate is a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate.

In some aspects, the detergent composition comprises from about 0.1 wt % to about 10 wt % of a fatty alcohol ethoxylate (e.g., a C₁₂-C₁₈ fatty alcohol ethoxylate with 1-15 moles of ethoxylate or a C₁₂-C₁₅ fatty alcohol ethoxylate with 7 moles of ethoxylate) relative to the total weight of the composition. For example, the acid can be present in an amount from about 0.1 wt % to about 8 wt %, about 0.1 wt % to about 5 wt %, about 0.5 wt % to about 10 wt %, about 0.5 wt % to about 8 wt %, about 0.5 wt % to about 5 wt %, about 1 wt % to about 10 wt %, about 1 wt % to about 8 wt %, about 1 wt % to about 5 wt %, about 1.5 wt % to about 10 wt %, about 1.5 wt % to about 8 wt %, about 1.5 wt % to about 5 wt %, about 2 wt % to about 10 wt %, about 2 wt % to about 8 wt %, about 2 wt % to about 5 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

The detergent composition comprises an anionic surfactant. In some aspects, the anionic surfactant comprises linear alkylbenzene sulfonate, a methyl ester sulfonate, or a combination thereof. The linear alkylbenzene sulfonate can have the structure of formula (II):

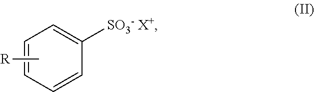

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The benzylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another. In general, the methyl ester sulfonate has the structure of formula (IIIa) or (IIIb):

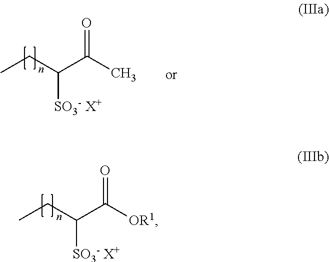

in which n is 10 to 16 (e.g., 10, 11, 12, 13, 14, 15, or 16) to form a C₁₂-C₁₈ alkyl (e.g., C₁₂, C₁₃, C₁₄, C₁₅, C₁₆, C₁₇, and C₁₈), R¹ is CH₃ or X⁺, and X⁺ is a cation that balances the charge.

In some aspects, the cation X⁺ of formula (II),(IIIa), and/or (IIIb) is a Group I cation, such as sodium cation or potassium cation, particularly sodium cation. In some aspects, the anionic surfactant comprises a methyl ester sulfonate.

In some aspects, the detergent composition comprises from about 10 wt % to about 25 wt % of anionic surfactant (e.g., linear alkylbenzene sulfonate and/or a methyl ester sulfonate) relative to the total weight of the composition. For example, the anionic surfactant can be present in an amount from about 10 wt % to about 22 wt %, about 10 wt % to about 20 wt %, about 12 wt % to about 25 wt %, about 12 wt % to about 22 wt %, about 12 wt % to about 20 wt %, about 12 wt % to about 18 wt %, about 14 wt % to about 25 wt %, about 14 wt % to about 22 wt %, about 14 wt % to about 20 wt %, about 14 wt % to about 18 wt %, about 15 wt % to about 25 wt %, about 15 wt % to about 22 wt %, about 15 wt % to about 20 wt %, about 15 wt % to about 18 wt %, about 16 wt % to about 20 wt %, about 16 wt % to about 18 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, or about 25 wt % of the total weight of the composition.

The detergent composition comprises a detergent polymer, which is any suitable polymer moiety that functions as a detergent. In some aspects, the detergent polymer is biodegradable. The detergent polymer can be based on acrylic acid, e.g., a homopolymer of acrylic acid, a polycarboxylate based on acrylic acid, a copolymer of acrylic acid and polystyrene, or a copolymer of maleic acid and acrylic acid. In some aspects, the detergent polymer comprises a homopolymer of acrylic acid.

In some aspects, the detergent composition comprises from about 0.1 wt % to about 10 wt % of a detergent polymer (e.g., a homopolymer of acrylic acid) relative to the total weight of the composition. For example, the detergent polymer can be present in an amount from about 0.1 wt % to about 8 wt %, about 0.1 wt % to about 5 wt %, about 0.1 wt % to about 3 wt %, about 0.5 wt % to about 10 wt %, about 0.5 wt % to about 8 wt %, about 0.5 wt % to about 5 wt %, about 0.5 wt % to about 3 wt %, about 1 wt % to about 10 wt %, about 1 wt % to about 8 wt %, about 1 wt % to about 5 wt %, about 1 wt % to about 3 wt %, about 1 wt % to about 2 wt %, about 1.5 wt % to about 10 wt %, about 1.5 wt % to about 8 wt %, about 1.5 wt % to about 5 wt %. about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

In some aspects, the powdered detergent composition further comprises a bleaching agent (e.g., chlorine or oxygen-releasing bleaching agents) and optionally a bleach activator. In some aspects, the bleaching agent comprises a hydrogen peroxide source as an oxygen-releasing bleaching agent. In some aspects, the hydrogen peroxide source comprises at least one inorganic perhydrate salt comprising a perborate salt, a percarbonate salt, a perphosphate salt, a persulfate salt, a persilicate salt, or a combination thereof. These salts can be counterbalanced by an alkali metal cation and/or an alkaline earth cation (e.g., sodium cation) to form, for example, an alkali metal percarbonate. In some aspects, the at least one inorganic perhydrate salt comprises sodium percarbonate.

In some aspects, the detergent composition comprises from about 1 wt % to about 30 wt % of a bleaching agent (e.g., a hydrogen peroxide source, such as an alkali metal percarbonate) relative to the total weight of the composition. For example, the bleaching agent can be present in an amount from about 1 wt % to about 25 wt %, about 1 wt % to about 20 wt %, about 1 wt % to about 15 wt %, about 1 wt % to about 10 wt %, about 1 wt % to about 8 wt %, about 1 wt % to about 7 wt %, about 1 wt % to about 5 wt %, about 2 wt % to about 30 wt %, about 2 wt % to about 25 wt %, about 2 wt % to about 20 wt %, about 2 wt % to about 15 wt %, about 2 wt % to about 10 wt %, about 2 wt % to about 8 wt %, about 2 wt % to about 7 wt %, about 2 wt % to about 5 wt %, about 3 wt % to about 30 wt %, about 3 wt % to about 25 wt %, about 3 wt % to about 20 wt %, about 3 wt % to about 15 wt %, about 3 wt % to about 10 wt %, about 3 wt % to about 8 wt %, about 3 wt % to about 7 wt %, about 3 wt % to about 5 wt %, about 5 wt % to about 30 wt %, about 5 wt % to about 25 wt %, about 5 wt % to about 20 wt %, about 5 wt % to about 15 wt %, about 5 wt % to about 10 wt %, about 10 wt % to about 30 wt %, about 10 wt % to about 25 wt %, about 10 wt % to about 20 wt %, about 10 wt % to about 15 wt %, about 2 wt % to about 30 wt %, about 12 wt % to about 25 wt %, about 12 wt % to about 20 wt %, about 12 wt % to about 15 wt %, about 15 wt % to about 30 wt %, about 15 wt % to about 25 wt %, about 15 wt % to about 20 wt %, about 18 wt % to about 30 wt %, about 18 wt % to about 25 wt %, about 18 wt % to about 20 wt %, about 20 wt % to about 30 wt %, about 20 wt % to about 25 wt %, about 22 wt % to about 30 wt %, about 22 wt % to about 25 wt %, about 25 wt % to about 30 wt %, about 28 wt % to about 30 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 12 wt %, about 15 wt %, about 18 wt %, about 20 wt %, about 22 wt %, about 25 wt %, about 28 wt %, or about 30 wt % of the total weight of the composition.

In some aspects, the composition further comprises a bleach activator, which is any suitable compound that enables the release of oxygen from the bleach compound. For example, the bleach activator can be tetraacetylethylenediamine (TAED), sodium 3,5,5-tri-methyl hexanoyloxybenzene sulfonate (iso-NOBS), sodium nonanoyloxybenzene sulfonate (NOBS), sodium acetoxybenzene sulfonate (ABS), pentaacetyl glucose, or any combination thereof. Bleach activators are described in U.S. Pat. No. 6,551,982, the disclosure of which is incorporated herein by reference in its entirety. In some aspects, the detergent composition comprises a bleaching agent (e.g., sodium percarbonate) and a bleach activator that is tetraacetylethylenediamine (TAED).

In some aspects, the detergent composition does not include a bleach activator. In other aspects, the detergent composition comprises from about 0.1 wt % to about 10 wt % of a bleach activator (e.g., TAED) relative to the total weight of the composition. For example, the bleach activator can be present in an amount from about 0.1 wt % to about 8 wt %, about 0.1 wt % to about 5 wt %, about 0.1 wt % to about 3 wt %, about 0.5 wt % to about 10 wt %, about 0.5 wt % to about 8 wt %, about 0.5 wt % to about 5 wt %, about 0.5 wt % to about 3 wt %, about 1 wt % to about 10 wt %, about 1 wt % to about 8 wt %, about 1 wt % to about 5 wt %, about 1 wt % to about 3 wt %, about 1 wt % to about 2 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %. about 0.6 wt %, about 0.7 wt %, about 0.8 wt %, about 0.9 wt %, about 1 wt %, about 1.1 wt %. about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

In some aspects, when a bleaching agent is present, a bleach catalyst can be further present in the detergent composition. The bleach catalyst can be a transition metal-containing catalyst, such as a Mn, Fe, Co, Ru, or Mo salen complexes or carbonyl complexes or Mn-, Fe-, Co-, Ru-, Mo-, Ti-, V-, and Cu-complexes with N-containing tripod ligands or Co-, Fe- Cu-, and Ru-ammine complexes.

Complexes of manganese in oxidation state II, III, IV, or V are particularly used and which contain one or more macrocyclic ligands with the donor functions N, NR, PR, O, and/or S. For example, a manganese-containing catalyst includes Mn(1,4,7-trimethyl-1,4,7-triazacyclononane)(OCH₃)₃—(PF₆), Mn(IV)₂(u-O)₃(1,4,7-trimethyl-1,4,7-triazacyclononane)₂-(PF₆)₂, Mn(III)₂(u-O)₁(u-OAc)₂(1,4,7-trimethyl-1,4,7-triazacyclononane)₂-(ClO₄)₂, Mn(IV)₄(u-O)₆(1,4,7-triazacyclononane)₄-(ClO₄)₂, Mn(III)Mn(IV)₄(u-O)₁(u-OAc)₂-(1,4,7-trimethyl-1,4,7-triazacyclononane)₂-(ClO₄)₃, and mixtures thereof. Other suitable ligands include 1,5,9-trimethyl-1,5,9-triazacyclododecane, 2-methyl-1,4,7-triazacyclononane, 2-methyl-1,4,7-triazacyclononane, 1,2,4,7-tetramethyl-1,4,7-triazacyclononane, and mixtures thereof. Cobalt-containing catalysts include, for example, cobalt pentaamine chloride salts, such as [Co(NH₃)₅Cl]Cl₂.

In some aspects, the detergent composition does not comprise a bleach catalyst. In other aspects, the detergent composition comprises from about 0.001 wt % to about 5 wt % of a bleach catalyst relative to the total weight of the composition. For example, the bleach catalyst can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %. about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition further comprises at least one (e.g., 1, 2, 3, 4, 5, or 6, etc.) enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the detergent composition comprises a protease, an amylase, or both a protease and an amylase.

In some aspects, the detergent composition comprises a total from about 0.01 wt % to about 5 wt % of at least one enzyme (e.g., a protease, an amylase, or both) relative to the total weight of the composition. For example, the total enzymes can be present in an amount from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the composition.

In an aspect, the detergent composition comprises soda ash, an acid, a fatty alcohol ethoxylate, an anionic surfactant, a detergent polymer, and a binder selected from a sugar, a starch, a polyol, and any combination thereof, wherein the composition is in the form of a powder. For example, the deterent composition can comprise:
about 10 wt % to about 40 wt % of soda ash;
about 10 wt % to about 30 wt % of acid;
about 0.1 wt % to about 10 wt % of a fatty alcohol ethoxylate;
about 10 wt % to about 25 wt % of anionic surfactant;
about 0.1 wt % to about 10 wt % of a detergent polymer; and
about 10 wt % to about 75 wt % of a binder selected from a sugar, a starch, a polyol, and any combination thereof,
wherein the composition is in the form of a powder. The amounts of each component will be selected to provide a detergent composition comprising 100 wt % of the total composition.

This detergent composition can optionally further comprise one or more of:
about 1 wt % to about 30 wt % of a bleaching agent;
about 0.1 wt % to about 10 wt % of a bleach activator;
about 0.001 wt % to about 5 wt % of a bleach catalyst; and
a total of about 0.01 wt % to about 5 wt % of at least one enzyme. The amounts of each component will be selected to provide a detergent composition comprising 100 wt % of the total composition.

In a specific aspect, the detergent composition comprises light soda ash, dense soda ash, citric acid, a C₁₂-C₁₅ fatty alcohol ethoxylate with 7 moles of ethoxylate, a methyl ester sulfonate, a homopolymer of acrylic acid, sodium percarbonate, tetraacetylethylenediamine (TAED), a protease, an amylase, and either sorbitol or dextrose. In particular, the detergent composition can comprise
about 10-20 wt % light soda ash,
about 10-20 wt % dense soda ash,
about 20-25 wt % citric acid,
about 1-5 wt % of a C₁₂-C₁₅ fatty alcohol ethoxylate with 7 moles of ethoxylate,
about 15-20 wt % of a methyl ester sulfonate,
about 1 to 3 wt % of a homopolymer of acrylic acid,
about 3-7 wt % of sodium percarbonate,
about 1-3 wt % of TAED,
about 1-2 wt % of a protease,
about 0.1-0.5 wt % of an amylase, and
about 10-20 wt % of sorbitol.

The amounts of each component will be selected to provide a detergent composition comprising 100 wt % of the total composition.

Alternatively, the detergent composition can comprise
about 10-20 wt % light soda ash,
about 10-20 wt % dense soda ash,
about 20-25 wt % citric acid,
about 1-5 wt % of a C₁₂-C₁₅ fatty alcohol ethoxylate with 7 moles of ethoxylate,
about 15-20 wt % of a methyl ester sulfonate,
about 1 to 3 wt % of a homopolymer of acrylic acid,
about 3-7 wt % of sodium percarbonate,
about 1-3 wt % of TAED,
about 1 to 2 wt % of a protease,
about 0.1 to 0.5 wt % of an amylase, and
about 10-20 wt % of dextrose.

The amounts of each component will be selected to provide a detergent composition comprising 100 wt % of the total composition.

In some aspects, the detergent composition can comprise at least one further additive, such as, a corrosion inhibitor, a sequestering agent, an electrolyte, a pH regulator, an optical brightener, a graying inhibitor, a color-transferring inhibitor, a foam regulator, a dye, a fragrance, or any combination thereof. In a further aspect, the detergent composition is substantially free of phosphates (i.e., “phosphate-free”), which is particularly advantageous from an environmental point of view. In an aspect, the detergent composition is substantially free of phosphonates (i.e., “phosphonate-free”), free of silicates (i.e., “silicate-free”), and/or free of polyethylene glycols (i.e., “PEG-free”). In particular aspects, the detergent composition is substantially free of phosphates, phosphonates, silicates, and PEG.

In some aspects, the powdered detergent composition is in the form of a compressed shape (e.g., compressed solid), such as a tablet, bar, or sphere. The compressed shape can comprise a single phase of the detergent composition. A compressed shape provides a pre-measured dose (i.e., unit dose) of the detergent composition without the mess associated with measuring liquid or free powder forms.

The weight of the compressed shape (e.g., tablet) is not particularly limited. In some embodiments, the compressed shape (e.g., tablet) has a weight that is about 5 g or more (e.g., about 10 g or more, about 15 g or more, about 20 g or more, about 25 g or more, or about 30 g or more) and about 50 g or less (e.g., about 45 g or less, about 40 g or less, about 35 g or less, about 30 g or less, about 25 g or less, about 20 g or less, about 15 g or less, or about 10 g or less). In some aspects, the compressed shape is about 15 g or about 30 g. If necessary, more than one unit dose can be used in a method of washing based on the size and soil level of the load.

In some aspects, a compressed shape (e.g., tablet) of the detergent composition dissolves within about 4 to about 15 minutes (e.g., about 4-12 min, about 4-10 min, about 4-8 min, about 4-6 min, about 5-15 min, about 5-12 min, about 5-10 min, or about 5-8 min) when the compressed shape (e.g., tablet) (30 g total weight) is added to 1 L water at about 21° C. (about 70° F.) with stirring using a tergotometer. In other aspects, a compressed shape (e.g., tablet) of the detergent composition will dissolve in 15 min or less (e.g., 12 min or less, 11 min or less, 10 min or less, 9 min or less, 8 min or less, 7 min or less, 6 min or less, or 5 min or less) under these conditions. When a compressed shape (e.g., tablet) dissolves according to these conditions, a fully clear or semi-translucent solution is provided. Such solution is desirable in that no dispersed solids (e.g., zeolites) remain that can be transferred to clothing or clog a drainage system. Moreover, the fast-dissolving compressed shapes (e.g., tablets) (e.g., dissolution time<15 min) have more active time in a wash load compared to a tablet that does not dissolve under the foregoing test conditions. A higher active loading means that smaller compressed shapes (i.e., smaller pre-measured doses) of the powdered detergent composition can be used for each wash load, thereby providing improved performance with less water usage, and/or lower associated costs (e.g., shipping costs).

In addition, a compressed shape (e.g., tablet or bar) formed from the powdered detergent composition was found to be strong and have improved handfeel, which can be beneficial for shipping, storage, handling, and/or stability.

In some aspects, a compressed shape (e.g., tablet) is formed using a compression force of about 5-30 kNewton (kN) (e.g., about 5-25 kN, about 8-24 kN, about 10-22 kN, about 10-20 kN, etc.).

In some aspects, a compressed shape (e.g., tablet) has a breaking strength of about 10 N or more (e.g., about 15 N or more, about 20 N or more, about 25 N or more, about 30 N or more, about 35 N or more, about 40 N or more, about 45 N or more) and about 60 N or less (e.g., about 55 N or less, about 50 N or less, about 45 N or less, about 40 N or less, about 35 N or less). In some aspects, the compressed shape has a breaking strength of about 15-50 N or about 20-45 N.

In a specific example, several tablets (about 30 g each) comprising a composition as described herein were formed using about 8-24 kN (about 0.8-2.5 tons) compression. The compressed tablets were observed to have breaking strengths within a range of about 20-45 N, such that the tablets did not break when dropped on the floor from a height of about 1.2-1.5 m (about 4-5 feet) and additionally, the compressed tablets did not break apart by hand (“the breaking tests”). The compressed tablets fully (100%) dissolved within about 10-14 min in a tergotometer test or about 4-6 min in a toploader machine. In some aspects, the compressed shape is formed using a compression force of about 5-30 kN and has a breaking strength of about 10-60 N. In other aspects, the compressed shape is formed using a compression force of about 8-24 kN and has a breaking strength of about 20-45 N.

In some aspects, a compressed shape (e.g., tablet) has improved stability. In a particular example, no degradation of the compressed shape was observed when a compressed shape (tablet only, no shrink wrap) was stored in a PE/EVOH/PE (polyethylene/ethylene vinyl alcohol/polyethylene) package, wherein the package was kept under conditions of about 39° C. (about 103° F.) at a relative humidity (RH) of about 80% for 2 months. With the improved stability and ability to withstand the breaking tests, the compressed shape form of the powdered detergent does not require to be shrink wrapped or being enclosed by another means (e.g., a pouch, a compartment, etc.) in order to be used as a single dose product and/or for an extended shelf life.

In some aspects, the powdered detergent composition, including a compressed shape thereof, can be in the form of a unit dose detergent pack. In some aspects, the detergent pack comprises a water-soluble film that encases the powdered detergent composition in either loose or compressed form. As used herein, the term “water-soluble” means that least 2 grams of the solute (e.g., the film) dissolves in 5 liters of solvent (e.g., water) for a solubility of at least 0.4 grams per liter (g/l) at a temperature of 25° C. unless otherwise specified. Upon contact with water (e.g., water in the wash cycle in a method of washing), the water-soluble film will release the detergent composition. The pouch can be a single compartment, and the powdered detergent composition is releasably disposed within the single compartment. Alternatively, the pouch can have two or more compartments, and the powdered detergent composition is releasably disposed within at least one of the two or more compartments. The other compartment(s) can include colorants or other components.

The water-soluble film is desirably strong, flexible, shock resistant, and non-tacky during storage at both high and low temperatures and high and low humidities. Non-limiting examples of suitable materials for the water-soluble film include polyvinyl alcohol, polyvinyl acetate, film-forming cellulosic polymers, polyacrylic acid, polyacrylamide, polyanhydride, polysaccharide, and combinations thereof. Unit dose detergent packs, including water-soluble films, are described in U.S. Pat. No. 11,492,574, the disclosure of which is incorporated herein by reference in its entirety.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

A preliminary mixture design of experiments of 5 ingredients: soda ash, a fatty alcohol ethoxylate (non-ionic surfactant, C₁₂-C₁₅ fatty alcohol ethoxylate with 7 moles of ethoxylate), microcrystalline cellulose (MCC), citric acid (“citric”), and linear alkylbenzene sulfonate (LAS) was undertaken to observe the ingredients interactions. The analyses of the tablets involved physical property measurements that included:
Dissolution in water at 21° C. (70° F.): performed with a tergotometer that includes 1 L of 21° C. (70° F.) water and a reciprocating stirrer to mimic a topload laundry machine. Dissolution measurements included: (1) dissolution wt % in 20 min, (2) full dissolution time (100% dissolution), and (3) floating in 21° C. (70° F.) water (e.g., time it takes for tablet pieces to float on top of the water as the tablet breaks down and dissolves).
Softness: a subjective test performed by rubbing a finger on the tablet to compare if the test tablet is softer versus other samples (ranking can be done with arbitrary numbers ranging from 0 to 3 (i.e., 0, 1, 2, or 3)).
Density: calculated by measuring the thickness of the tablet and deriving its volume (density=mass/volume).
Force to break the tablet in a compression test is done with a typical Tinius Olsen with HT400 Pneumatic Grip Controller instrument, in which the tablet is compressed vertically to its diameter.

Test compositions were prepared with the components (C1 through C5) and amounts as listed in Table 1 below. Tablets weighing 15 g and 45 mm in diameter were made from the compositions shown under 6 metric tons of pressure.

TABLE 1

| | C1 | | | C4 | | Wt % | 100% |
|---|---|---|---|---|---|---|---|
| Run | Soda | C2 | C3 | Citric | C5 | Dissolution | Dissolution |
| # | Ash | 25-7 | MCC | Acid | LAS | (20 min) | (min:sec) |
| 1 | 0.850 | 0.00 | 0.000 | 0.000 | 0.15 | 98.00 | |
| 2 | 0.000 | 0.00 | 0.850 | 0.000 | 0.15 | 100.00 | |
| 3 | 0.000 | 0.00 | 0.000 | 0.850 | 0.15 | 100.00 | |
| 4 | 0.850 | 0.12 | 0.000 | 0.000 | 0.03 | 98.00 | |
| 5 | 0.000 | 0.12 | 0.850 | 0.000 | 0.03 | 84.63 | 4:15 |
| 6 | 0.000 | 0.12 | 0.000 | 0.850 | 0.03 | 100.00 | 3:00 |
| 7 | 0.650 | 0.00 | 0.000 | 0.000 | 0.35 | 46.91 | |
| 8 | 0.000 | 0.00 | 0.650 | 0.000 | 0.35 | 54.63 | |
| 9 | 0.000 | 0.00 | 0.000 | 0.650 | 0.35 | 100.00 | 9:50 |
| 10 | 0.650 | 0.12 | 0.000 | 0.000 | 0.23 | 45.14 | |
| 11 | 0.000 | 0.12 | 0.650 | 0.000 | 0.23 | 50.63 | |
| 12 | 0.000 | 0.12 | 0.000 | 0.650 | 0.23 | 100.00 | 11:45 |
| 13 | 0.250 | 0.06 | 0.250 | 0.250 | 0.19 | 98.00 | |
| 14 | 0.550 | 0.03 | 0.125 | 0.125 | 0.17 | 84.91 | |
| 15 | 0.125 | 0.03 | 0.550 | 0.125 | 0.17 | 86.97 | 15:20 |
| 16 | 0.125 | 0.03 | 0.125 | 0.550 | 0.17 | 100.00 | |
| 17 | 0.550 | 0.09 | 0.125 | 0.125 | 0.11 | 72.63 | |
| 18 | 0.025 | 0.09 | 0.550 | 0.125 | 0.11 | 63.14 | |
| 19 | 0.125 | 0.09 | 0.125 | 0.550 | 0.11 | 100.00 | 17:30 |
| 20 | 0.450 | 0.03 | 0.125 | 0.125 | 0.27 | 62.57 | |
| 21 | 0.125 | 0.03 | 0.450 | 0.125 | 0.27 | 65.20 | |
| 22 | 0.125 | 0.03 | 0.125 | 0.450 | 0.27 | 98.00 | 15:20 |
| 23 | 0.450 | 0.09 | 0.125 | 0.125 | 0.21 | 55.14 | |
| 24 | 0.125 | 0.09 | 0.450 | 0.125 | 0.21 | 52.11 | |
| 25 | 0.125 | 0.09 | 0.125 | 0.450 | 0.21 | 98.00 | |

After studying the compositions of Table 1. the following observations were derived.

Following the dissolution test described, eleven samples dissolved 50% to 100% in water within 20 min. Seven of the samples dissolved 100% within 4-17 min. Four samples partially dissolved (at least 50% with parts remaining floating on top of the water) over 8-15 min.

Increasing the levels of microcrystalline cellulose and linear alkylbenzene sulfonate provided decreased density and increased strength.

Increasing the levels of soda ash, a fatty alcohol ethoxylate, and citric acid increased density and decreased strength.

The softness of the tablet was best with a balanced fatty alcohol ethoxylate to linear alkylbenzene sulfonate weight ratio (e.g., 1:1 to 1:6).

### Example 2

Based on the observations from Example 1, a model was derived for optimum performance (composite desirability) with respect to tablet dissolution, softness, and strength (response curvature/surface) that combines the contribution of each ingredient. Seven of the most promising compositions were selected and additional ingredients were included to study performance. Some of the conclusions are as follows and resulted in the formulations set forth in Table 4.

Exemplary compositions broke down within about 4-8 min and fully dissolved, meaning the solutions were 100% clear or translucent at less than 12 min in the standard dissolution lab test. The lab test was performed with a tergotometer that included 1 L of about 21° C. (about 70° F.) water and a reciprocating stirrer to mimic a topload laundry machine. The same test was then run using a toploader laundry machine as a realistic laundry test. Under the realistic laundry test conditions, full dissolution was within 6 min or less. In particular, depending on the tablet composition, at 2 min about 50% of the tablet was left, at 4 min full breakdown was observed, and full dissolution was at 6 min.

The average breaking strength of model compositions was measured at 127 N, which is close to the target of 100 N predicted by a model. Compared to commercially available detergent bars, the inventive tablets were stronger and had a non-powdery, nice handfeel.

Additional formulation changes (e.g., surfactant, enzyme, bleach activator) were shown to improve performance. Table 2 shows a comparison of tablet formulations comprising methyl ester sulfonate (MES) vs linear alkylbenzene sulfonate (LAS) at 15° C. (59° F.). As seen in Table 2, MES provided slightly improved detergent performance, notably under cold water wash conditions.

TABLE 2
MES Tablet vs LAS Tablet

| | |
|---|---|
| MES Tablet Wins | 6 |
| MES Tablet Losses | 2 |
| Parity | 12 |

Table 3 shows a comparison at 32° C. (90° F.) of a modified MES-containing tablet compared to a loose powder containing sorbitol, modified MES, and enzymes. As seen in Table 3, the loose powder containing sorbitol, modified MES, and enzymes provided improved detergent performance compared to the MES tablet.

TABLE 3
Modified MES Tablet vs Sorbitol/Modified
MES/Enzyme Loose Powder

| | |
|---|---|
| Modified MES Tablet Wins | 2 |
| Modified MES Tablet Losses | 8 |
| Parity | 10 |

### Example 3

Based on the observations from Examples 1 and 2, the following exemplary formulations were prepared (Table 4).

TABLE 4

Composition

| | A | B |
|---|---|---|
| Raw Material | wt % | wt % |
| soda ash light | 17 | 17 |
| soda ash dense | 15.75 | 15.75 |
| C₁₂-C₁₅ fatty alcohol ethoxylate | 3 | 3 |
| with 7 moles of ethoxylate | | |
| citric acid | 22 | 22 |
| sorbitol | 15 | — |
| dextrose | — | 15 |
| homopolymer of acrylic acid | 1.25 | 1.25 |
| MES | 17 | 17 |
| sodium percarbonate | 5 | 5 |
| TAED | 2.38 | 2.38 |
| protease | 1.4 | 1.4 |
| amylase | 0.225 | 0.225 |
| Total | 100 | 100 |

Compositions A and B were tested for wash performance against a commercially available product, ALL™ Free Clear (Henkel Corp., Germany) (“AFC”), in 30 g samples at 15° C. (59° F.) and 32° C. (90° F.). The results are shown in Table 5.

TABLE 5

| | 15° C. (59° F.) | | 32° C. (90° F.) | |
|---|---|---|---|---|
| | Tablet A | Tablet B | Tablet A | Tablet B |
| | vs | vs | vs | vs |
| | AFC Powder | AFC powder | AFC Powder | AFC powder |
| Tablet Wins | 7 | 6 | 12 | 12 |
| Tablet Losses | 2 | 2 | 2 | 3 |
| Parity | 11 | 12 | 6 | 5 |

As seen in Table 5, the performances of tablets A and B were both very high compared to AFC powder, with performance being slightly better at 32° C. (90° F). No residual solid from tablet A or B was confirmed in the wash test. Full dissolution of both tablets was observed at 6 min (50% dissolution in 2 min, breakdown at 4 min, and complete dissolution at 6 min at 15° C. (59° F.).

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A detergent composition comprising soda ash, an acid, a fatty alcohol ethoxylate, an anionic surfactant, a detergent polymer, and a binder selected from a sugar, a starch, a polyol, and any combination thereof, wherein the composition is in the form of a powder.

2. The detergent composition of claim 1, wherein the soda ash comprises light soda ash, medium dense soda ash, dense soda ash, sodium bicarbonate, or a combination thereof.

3. The detergent composition of claim 2, wherein the soda ash comprises light soda ash and dense soda ash in a weight ratio of about 1:1.

4. The detergent composition of claim 1, wherein the acid is an organic acid.

5. The detergent composition of claim 4, wherein the organic acid comprises citric acid.

6. The detergent composition of claim 1, wherein the fatty alcohol ethoxylate is a C₁₂-C₁₈ fatty alcohol ethoxylate with 1-15 moles of ethoxylate.

7. The detergent composition of claim 1, wherein the fatty alcohol ethoxylate comprises a C₁₂-C₁₅ fatty alcohol ethoxylate with 7 moles of ethoxylate.

8. The detergent composition of claim 1, wherein the anionic surfactant comprises linear alkylbenzene sulfonate, a methyl ester sulfonate, or a combination thereof.

9. The detergent composition of claim 1, wherein the anionic surfactant comprises a methyl ester sulfonate.

10. The detergent composition of claim 1, wherein the detergent polymer comprises a homopolymer of acrylic acid.

11. The detergent composition of claim 1, wherein the composition further comprises a bleaching agent and optionally a bleach activator.

12. The detergent composition of claim 11, wherein the bleaching agent comprises a hydrogen peroxide source.

13. The detergent composition of claim 12, where the composition further comprises tetraacetylethylenediamine (TAED) as a bleach activator.

14. The detergent composition of claim 1, wherein the composition further comprises at least one enzyme.

15. The detergent composition of claim 14, wherein the at least one enzyme comprises a protease, an amylase, a mannanase, a lactase, a lipase, a perhydrolase, an oxidoreductase, an endocellulase, an exocellulase, or a combination thereof.

16. The detergent composition of claim 1, wherein the composition comprises light soda ash, dense soda ash, citric acid, a C₁₂-C₁₅ fatty alcohol ethoxylate with 7 moles of ethoxylate, a methyl ester sulfonate, a homopolymer of acrylic acid, sodium percarbonate, tetraacetylethylenediamine (TAED), a protease, an amylase, and either sorbitol or dextrose.

17. The detergent composition of claim 1, wherein the composition is in the form of a compressed shape.

18. The detergent composition of claim 17, wherein the compressed shape dissolves within about 4 to about 15 minutes when the compressed shape is added to 1 L water at about 21° C. (about 70° F.) with stirring.

19. The detergent composition of claim 17, wherein the compressed shape is not enclosed in a pouch or shrink-wrapped.

20. The detergent composition of claim 19, wherein the compressed shape has a breaking strength within a range of about 20-45 N.
